(19) United States
(12) Patent Application Publication
(10) Pub. No.: US 2017/0199693 A1
(43) Pub. Date: Jul. 13, 2017

(54) ELECTRONIC SYSTEM HAVING POWER-CONDITION-AWARE HYBRID STORAGE DEVICE AND METHOD FOR OPERATION OF HYBRID STORAGE DEVICE IN ELECTRONIC SYSTEM

(71) Applicant: JMicron Technology Corp., Hsin-Chu (TW)

(72) Inventor: George Fong, Irvine, CA (US)

(21) Appl. No.: 15/355,064

(22) Filed: Nov. 18, 2016

(30) Foreign Application Priority Data
Jan. 12, 2016 (TW) 105100759

(51) Int. Cl. G06F 3/06

(52) U.S. Cl. CPC G06F 3/0625; G06F 3/0679; G06F 3/0655; G06F 3/0653; G06F 3/068

(57) ABSTRACT

The present invention provides an electronic system having a power-condition-aware hybrid storage device and a method for the operation of the hybrid storage device in the electronic system. The electronic system comprises: a host and a hybrid storage device. The host comprises a detecting unit, and the detecting unit is utilized for detecting a power condition of the host to generate a first detecting result and detecting an operation condition of the host to generate a second detecting result. The hybrid storage device comprises: a plurality of non-volatile memory units, a hard drive unit, and a control unit. The control unit is utilized for receiving the first detecting result and the second detecting result from the detecting unit in the host and determining whether to turn on the hard drive unit according to the first detecting result and the second detecting result.

### BACKGROUND OF THE INVENTION

1. Field of the Invention

The present invention relates to a hybrid storage device and a method for operating the hybrid storage device in an electronic system, and more particularly, to an electronic system having a power-condition-aware hybrid storage device and a method for operation of the hybrid storage device in the electronic system.

2. Description of the Prior Art

In general, the conventional hard drive has advantages of larger volume and lower cost, but the conventional hard drive has disadvantages of slower speed and higher power consumption compared with the solid state disk (SSD). Although the SSD has advantages higher speed and slower power consumption, the SSD has disadvantages of smaller volume and higher cost compared with the conventional hard drive. Thus, there is a hybrid drive trying to combine the advantages of the conventional hard drive and the SSD in the market. However, the conventional hybrid drive usually uses the conventional hard drive and the SSD at the same time, and thus the conventional hybrid drive is not capable of solving the problem of high power consumption of the conventional hard drive.

### SUMMARY OF THE INVENTION

It is therefore one of the objectives of the present invention to provide an electronic system having a power-condition-aware hybrid storage device to save power and a method for operation of the hybrid storage device in the electronic system, so as to solve the above problem.

In accordance with an embodiment of the present invention, an electronic system having a power-condition-aware hybrid storage device is disclosed. The electronic system comprises: a host and a hybrid storage device, wherein the hybrid storage device is coupled to the host. The host comprises a detecting unit, and the detecting unit is utilized for detecting a power condition of the host to generate a first detecting result and detecting an operation condition of the host to generate a second detecting result. The hybrid storage device comprises: a plurality of non-volatile memory units, a hard drive unit, and a control unit. The control unit is coupled to the detecting unit, the plurality of non-volatile memory units, and the hard drive unit, and utilized for receiving the first detecting result and the second detecting result from the detecting unit in the host and determining whether to turn on the hard drive unit according to the first detecting result and the second detecting result.

In accordance with an embodiment of the present invention, a method for an electronic system comprising a host and a hybrid storage device, wherein the host comprises a detecting unit, and the hybrid storage device comprises a plurality of non-volatile memory units, a hard drive unit, and a control unit is disclosed. The method comprises: utilizing the detecting unit to detect a power condition of the host to generate a first detecting result and detecting an operation condition of the host to generate a second detecting result; and utilizing the control unit to receive the first detecting result and the second detecting result from the detecting unit in the host and determine whether to turn on the hard drive unit according to the first detecting result and the second detecting result.

Briefly summarized, the electronic system having the power-condition-aware hybrid storage device to save power and the method for the electronic system disclosed by the present invention can make the hybrid storage device in the electronic system have a large storage volume as the hard drive unit, or make the hybrid storage device have a high speed as the solid state disk (SSD) and make the electronic system save more power and increase battery life of the host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of an electronic system in accordance with an embodiment of the present invention.

FIG. 2 is a flowchart showing a method for the electronic system in accordance with the operation schemes of the electronic system in FIG. 1 in the embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

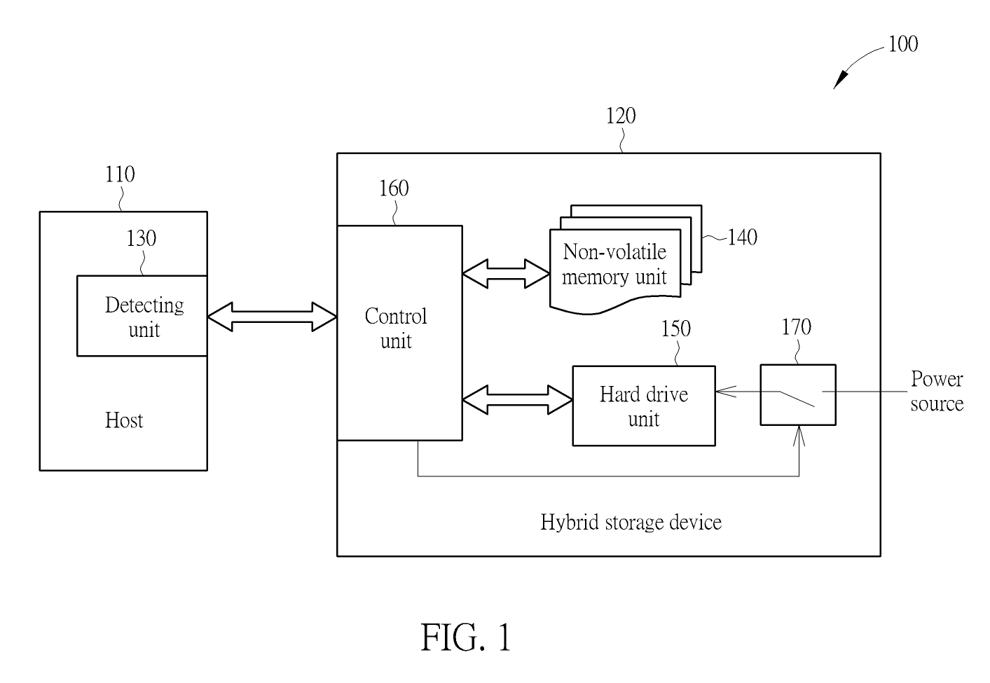

Please refer to FIG. 1. FIG. 1 shows a simplified block diagram of an electronic system 100 in accordance with an embodiment of the present invention, wherein the electronic system 100 can be a notebook computer. As shown in FIG. 1, the electronic system 100 comprises: a host 110 and a hybrid storage device 120, wherein the hybrid storage device 120 is coupled to the host 110. The host 110 comprises a detecting unit 130, and the detecting unit 130 is utilized for detecting a power condition of the host 110 to generate a first detecting result and detecting an operation condition of the host 110 to generate a second detecting result.

The hybrid storage device 120 comprises: a plurality of non-volatile memory units 140, a hard drive unit 150, a control unit 160, and a switch unit 170, wherein the plurality of non-volatile memory units 140 can be a plurality of NAND type Flash memories or a solid state disk (SSD), and the control unit 160 can be a SSD control unit. In general, the storage volume of the hard drive unit 150 is much larger than the plurality of non-volatile memory units 140 (i.e. the SSD).

The switch unit 170 is coupled between the hard drive unit 150 and a power source, and the control unit 160 is coupled to the detecting unit 130, the plurality of non-volatile memory units 140 140, and the hard drive unit 150. The control unit 160 is utilized for receiving the first detecting result and the second detecting result from the detecting unit in the host and determining whether to turn on the switch unit 170 to connect the hard drive unit 150 to the power source to turn on the hard drive unit 150 according to the first detecting result and the second detecting result.

When the first detecting result indicates that the power condition of the host 110 is connecting to an external power source (not shown) or the second detecting result indicates that the host 110 has to read a non-existent data in the plurality of non-volatile memory units 140 (i.e. the data stored in the hard drive unit 150), the control unit 160 determines to turn on the switch unit 170 to connect the hard drive unit 150 to the power source to turn on the hard drive unit 150 in the hybrid storage device 120 of the host 110, so that the electronic system 100 can use the hard drive unit 150 to read and store the data. Thus, the hybrid storage device 120 will have a large storage volume to use (since the storage volume of the hard drive unit 150 is much larger than the plurality of non-volatile memory units 140 (i.e. the SSD)).

In addition, when the first detecting result indicates that the power condition of the host 110 is not connecting to any external power source and the second detecting result indicates that the host 110 does not have to read the non-existent data in the plurality of non-volatile memory units 140 (i.e. the data stored in the hard drive unit 150), the control unit 160 determines to turn off the switch unit 170 to disconnect the hard drive unit 150 with the power source to turn off the hard drive unit 150, wherein the host 110 further comprises a battery unit (not shown). In other words, when the first detecting result and the second detecting result indicate that the power condition of the host 110 is only using the battery unit, and the host 110 does not have to read the non-existent data in the plurality of non-volatile memory units 140, the control unit 160 will determine to cut off the power supply of the hard drive unit 150 to turn off the hard drive unit 150, so that the electronic system 100 can use the plurality of non-volatile memory units 140 to read and store the data. Thus, the hybrid storage device 120 will have a high speed as the SSD. In addition, since the plurality of non-volatile memory units 140 have lower power consumption, the electronic system 100 can save more power and increase battery life of the battery unit in the host 110.

In addition, when the host 110 is connected to an external power source, the control unit 160 will execute a predetermined algorithm to transmit data between the plurality of non-volatile memory units 140 and the hard drive unit 150 to maintain the data consistency between the plurality of non-volatile memory units 140 and the hard drive unit 150, and make the plurality of non-volatile memory units 140 have enough storage volume to receive new data.

Please note that the above embodiment is only for an illustrative purpose and is not meant to be a limitation of the present invention. For example, the switch unit 170 can be omitted or integrated in the hard drive unit 150 in other embodiments. In other words, the control unit 160 can directly determines whether to turn on the hard drive unit 150 according to the first detecting result and the second detecting result.

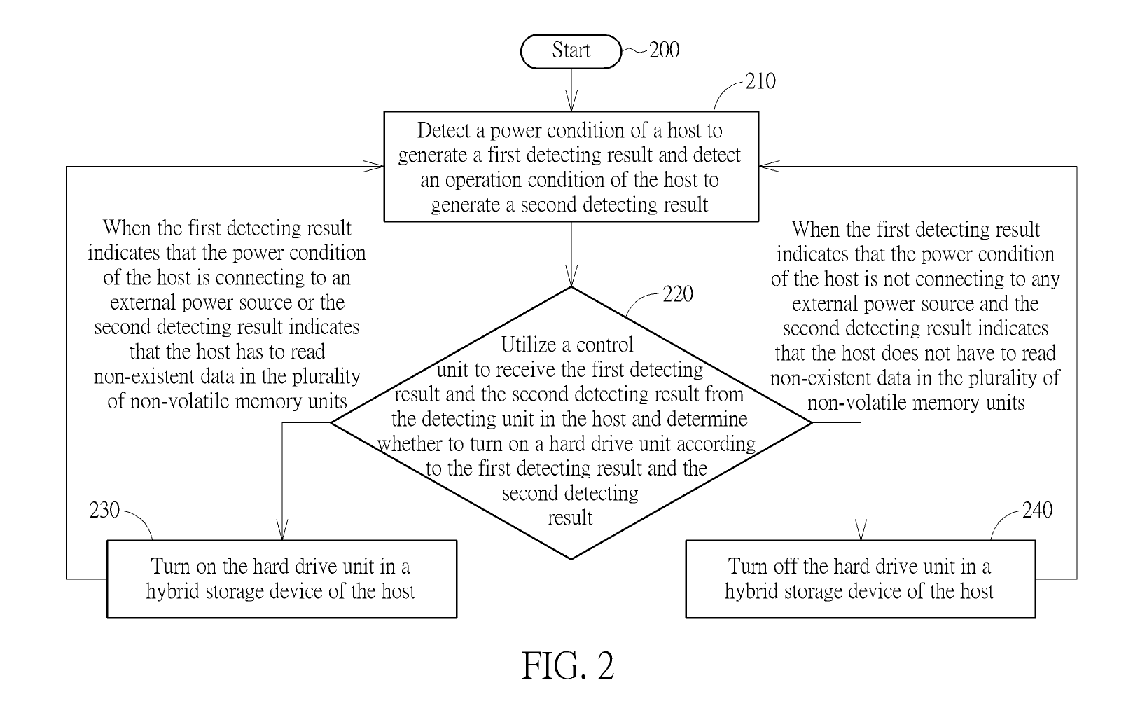

Please refer to FIG. 2. FIG. 2 is a flowchart showing a method for the electronic system 100 in accordance with the above operation schemes of the electronic system 100 in the embodiment of the present invention. Provided that substantially the same result is achieved, the steps of the process flowchart need not be in the exact order shown in FIG. 2 and need not be contiguous, that is, other steps can be intermediate. The method of the present invention comprises the following steps:

Step 200: Start.

Step 210: Detect a power condition of a host to generate a first detecting result and detect an operation condition of the host to generate a second detecting result.

Step 220: Utilize a control unit to receive the first detecting result and the second detecting result from the detecting unit in the host and determine whether to turn on a hard drive unit according to the first detecting result and the second detecting result; when the first detecting result indicates that the power condition of the host is connecting to an external power source or the second detecting result indicates that the host has to read non-existent data in the plurality of non-volatile memory units, go to Step 230; and when the first detecting result indicates that the power condition of the host is not connecting to any external power source and the second detecting result indicates that the host does not have to read non-existent data in the plurality of non-volatile memory units, go to Step 240.

Step 230: Turn on the hard drive unit in a hybrid storage device of the host.

Step 240: Turn off the hard drive unit in a hybrid storage device of the host.

In addition, the electronic system 100 can further comprise a switch unit coupled between the hard drive unit and a power source, and the step of utilizing the control unit to receive the first detecting result and the second detecting result from the detecting unit in the host and determine whether to turn on the hard drive unit according to the first detecting result and the second detecting result can comprise: utilizing the control unit to receive the first detecting result and the second detecting result from the detecting unit and determine whether to turn on the switch unit to connect the hard drive unit to the power source to turn on the hard drive unit according to the first detecting result and the second detecting result, wherein the step of utilizing the control unit to receive the first detecting result and the second detecting result from the detecting unit in the host and determine whether to turn on the switch unit to connect the hard drive unit to the power source to turn on the hard drive unit according to the first detecting result and the second detecting result can further comprise: when the first detecting result indicates that the power condition of the host is connecting to an external power source or the second detecting result indicates that the host has to read a non-existent data in the plurality of non-volatile memory units, the control unit determines to turn on the switch unit to turn on the hard drive unit in the hybrid storage device of the host; and when the first detecting result indicates that the power condition of the host is not connecting to any external power source and the second detecting result indicates that the host does not have to read the non-existent data in the plurality of non-volatile memory units, the control unit determines to turn off the switch unit to turn off the hard drive unit in the hybrid storage device of the host.

Briefly summarized, the electronic system having the power-condition-aware hybrid storage device to save power and the method for the electronic system disclosed by the present invention can make the hybrid storage device in the electronic system have a large storage volume as the hard drive unit, or make the hybrid storage device have a high speed as the SSD and make the electronic system save more power and increase battery life of the host.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system having a power-condition-aware hybrid storage device, the electronic system comprising:
a host, comprising:
a detecting unit, for detecting a power condition of the host to generate a first detecting result and detecting an operation condition of the host to generate a second detecting result; and
a hybrid storage device, coupled to the host, comprising:
a plurality of non-volatile memory units;
a hard drive unit; and
a control unit, coupled to the detecting unit, the plurality of non-volatile memory units, and the hard drive unit, for receiving the first detecting result and the second detecting result from the detecting unit in the host and determining whether to turn on the hard drive unit according to the first detecting result and the second detecting result.

2. The electronic system of claim 1, wherein when the first detecting result indicates that the power condition of the host is connecting to an external power source or the second detecting result indicates that the host has to read a non-existent data in the plurality of non-volatile memory units, the control unit determines to turn on the hard drive unit in the hybrid storage device of the host; and when the first detecting result indicates that the power condition of the host is not connecting to any external power source and the second detecting result indicates that the host does not have to read the non-existent data in the plurality of non-volatile memory units, the control unit determines to turn off the hard drive unit in the hybrid storage device of the host.

3. The electronic system of claim 1, further comprising:
a switch unit, coupled between the hard drive unit and a power source;
wherein the control unit receives the first detecting result and the second detecting result from the detecting unit and determines whether to turn on the switch unit to connect the hard drive unit to the power source to turn on the hard drive unit according to the first detecting result and the second detecting result.

4. The electronic system of claim 3, wherein when the first detecting result indicates that the power condition of the host is connecting to an external power source or the second detecting result indicates that the host has to read a non-existent data in the plurality of non-volatile memory units, the control unit determines to turn on the switch unit to turn on the hard drive unit in the hybrid storage device of the host; and when the first detecting result indicates that the power condition of the host is not connecting to any external power source and the second detecting result indicates that the host does not have to read the non-existent data in the plurality of non-volatile memory units, the control unit determines to turn off the switch unit to turn off the hard drive unit in the hybrid storage device of the host.

5. The electronic system of claim 1, wherein the host further comprises:
a battery unit.

6. The electronic system of claim 1, wherein the plurality of non-volatile memory units are a plurality of NAND type Flash memories.

7. The electronic system of claim 1, wherein the control unit is a Solid State Drive (SSD) control unit.

8. A method for an electronic system comprising a host and a hybrid storage device, wherein the host comprises a detecting unit, and the hybrid storage device comprises a plurality of non-volatile memory units, a hard drive unit, and a control unit, the method comprising:
utilizing the detecting unit to detect a power condition of the host to generate a first detecting result and detecting an operation condition of the host to generate a second detecting result; and
utilizing the control unit to receive the first detecting result and the second detecting result from the detecting unit in the host and determine whether to turn on the hard drive unit according to the first detecting result and the second detecting result.

9. The method of claim 8, wherein the step of utilizing the control unit to receive the first detecting result and the second detecting result from the detecting unit in the host and determine whether to turn on the hard drive unit according to the first detecting result and the second detecting result comprises:
when the first detecting result indicates that the power condition of the host is connecting to an external power source or the second detecting result indicates that the host has to read a non-existent data in the plurality of non-volatile memory units, the control unit determines to turn on the hard drive unit in the hybrid storage device of the host; and
when the first detecting result indicates that the power condition of the host is not connecting to any external power source and the second detecting result indicates that the host does not have to read the non-existent data in the plurality of non-volatile memory units, the control unit determines to turn off the hard drive unit in the hybrid storage device of the host.

10. The method of claim 8, wherein the electronic system further comprises a switch unit coupled between the hard drive unit and a power source, and the step of utilizing the control unit to receive the first detecting result and the second detecting result from the detecting unit in the host and determine whether to turn on the hard drive unit according to the first detecting result and the second detecting result comprises:
utilizing the control unit to receive the first detecting result and the second detecting result from the detecting unit and determine whether to turn on the switch unit to connect the hard drive unit to the power source to turn on the hard drive unit according to the first detecting result and the second detecting result.

11. The method of claim 10, wherein the step of utilizing the control unit to receive the first detecting result and the second detecting result from the detecting unit in the host and determine whether to turn on the switch unit to connect the hard drive unit to the power source to turn on the hard drive unit according to the first detecting result and the second detecting result comprises:
when the first detecting result indicates that the power condition of the host is connecting to an external power source or the second detecting result indicates that the host has to read a non-existent data in the plurality of non-volatile memory units, the control unit determines to turn on the switch unit to turn on the hard drive unit in the hybrid storage device of the host; and
when the first detecting result indicates that the power condition of the host is not connecting to any external power source and the second detecting result indicates that the host does not have to read the non-existent data in the plurality of non-volatile memory units, the control unit determines to turn off the switch unit to turn off the hard drive unit in the hybrid storage device of the host.
